(19) United States
(12) Patent Application Publication
(10) Pub. No.: US 2023/0240449 A1
(43) Pub. Date: Aug. 3, 2023

(54) Device for Relieving the Weight of Bed Covers on Feet

(71) Applicant: Brenda DW Lanzana, Asheville, NC (US)

(72) Inventor: Brenda DW Lanzana, Asheville, NC (US)

(21) Appl. No.: 18/105,210

(22) Filed: Feb. 2, 2023

Related U.S. Application Data
(60) Provisional application No. 63/305,741, filed on Feb. 2, 2022.

(51) Int. Cl. A47C 21/02

(52) U.S. Cl. CPC A47C 21/024

(57) ABSTRACT

A device meant for relieving weight of covers on the user's feet. A base connects to a plurality of adjustable base uprights which are affixed to a plurality of curved shields which prevent the user's feet from coming into contact with the blanket. Such a device mitigates stretched ankle tendons, the pointed toe position that causes leg cramping, some symptoms of restless leg syndrome, and unhealthy pressure on the feet and ankles.

### CROSS-REFERENCE TO RELATED APPLICATIONS

This application claims benefit to the U.S. provisional application 63/305,741 filed on Feb. 2, 2022 and incorporates that application in its entirety.

### PRIOR ART

U.S. Pat. No. 4,841,589, Jun. 1989 to Moore, Bed Cover Support Structure.

U.S. Pat. No. 5,978,991, Nov. 1999 to Miles, Device for Relieving Weight of a Blanket on Feet and Supporting Feet of Paralyzed Persons.

U.S. Pat. No. 6,163,901, Dec. 2000 to Sargent, Blanket Elevation Device.

U.S. Pat. No. 6,834,403, Dec. 2004 to Elliott, Blanket Elevation Apparatus.

U.S. Pat. No. 7,555,795, Jul. 2009 to Feil, Toe Rest in Bed and Blanket Support.

U.S. Pat. No. 8,490,229, Jul. 2013 to Mintz, Gusseted Foot Canopy for Bed Top Sheets, Blankets, Quilts or Beds and the Like.

### Other Publications:

Blanket Lifter, https://www.amazon.com/dp/B08MQ5VJVJ/ref=cm_sw_em_r_mt_dp_ABFB93G8VVKEE07H8SAP

### BACKGROUND OF THE INVENTION

An object of this invention is to provide a support structure for bed covers and/or blankets that allows a user to lay or sleep comfortably on their back without the pressure of the bed covers and/or blankets pulling down on the user's feet, toes, and ankles.

This helps mitigate the pain caused by unnatural, unsafe positions of the feet while sleeping. The invention will mitigate stretched ankle tendons, the pointed toe position that causes leg cramping, some symptoms of restless leg syndrome, and unhealthy pressure on the feet and ankles.

The invention can also be useful for people with rheumatoid arthritis, skin conditions, and bed sores. Some people just prefer to sleep with the blankets supported off of their feet. Another object of this invention is to provide a device for relieving the weight of bed covers on feet that works with a conventional bed.

Another object of this invention is to provide a device for relieving the weight of bed covers on feet that is adjustable to work with various mattress depths and feet lengths.

Another object of this invention is to provide a device for relieving the weight of bed covers on feet that will not be touched by the feet of the user.

Another object of this invention is to provide a device for relieving the weight of bed covers on feet that will be easy and affordable to manufacture and ship.

One advantage of the invention is that it has three arms to provide improved lifting of the bed covers. A users' two feet fit in the spaces between the three arms of the invention.

Another advantage of the invention is that a user's feet do not touch the invention while in use, which also allows the user to sleep and move in other normal sleeping positions without interference or contact from the device.

Another advantage of the invention is that it is easily adjustable for different depths of mattresses and different lengths of feet.

Another advantage of the invention is that it works with conventional mattresses and bed covers.

Another advantage of the invention is that it is able to hold heavy bed covers.

Another advantage of the invention is that it is portable and packable for the traveling user.

### BRIEF DESCRIPTION OF DRAWINGS

FIG. 1 is a side view of a device for relieving the weight of bed covers on feet.

FIG. 2 is a rear view of the device for relieving the weight of bed covers on feet.

FIG. 3 is a cutaway view of the device for relieving the weight of bed covers on feet in use.

### DRAWINGS—REFERENCE NUMERALS

2 curved shield

4 rounded end of curved shield

6 top of base upright

8 hole in base upright

10 first hole

12 second hole

14 third hole

16 base upright

18 bottom of curved shield

20 base

21 base mounting screw

22 hole in base upright

24 first curved shield

26 first upright adjustment screw set

27 first hole in base upright and in curved shield

28 second upright adjustment screw set

29 second hole in base upright and in curved shield

30 hole in base upright

32 first base upright

33 second base upright

34 base

35 third base upright

36 base mounting screw

38 second curved shield

40 third curved shield

42 top of base upright

44 bed cover

46 cut away view of bed cover

48 plurality of curved shields

50 foot of a user

52 mattress

54 box springs

56 base

58 plurality of base uprights

60 cut away edge of bed

### DETAILED DESCRIPTION OF THE INVENTION

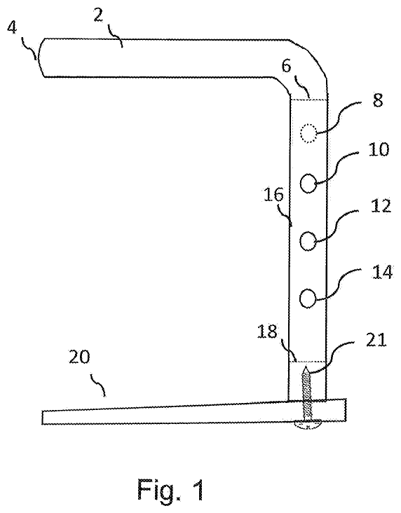

In FIG. 1 the invention is shown in a side view. A base 20 is of sufficient length to firmly hold the invention upright when placed between a mattress and box springs. The width of base 20 is less than the width of a mattress and of sufficient width to support at least three base uprights.

The height of base 20 varies from end to end, with the taller height on the end with a screw 21. The base 20 may be made of any rigid material of sufficient strength and may rubber coated. The base mounting screw 21 screws through the base into a base upright 16.

The base upright 16 has a solid end to accept the base mounting screw 21. Other forms of attachment could also be utilized. The base upright 16 is tube shaped and contains a first hole 10, a second hole 12, and a third hole 14. A curved shield 2 is tube-shaped and sufficiently larger or smaller than the base upright 16 so that part of the two tubes fit inside each other.

The curved shield 2 has a first hole 10, a second hole 12, and a hole 8 corresponding with holes in the base upright. Upright adjustment screws which come in two-part sets are used in a plurality of holes to secure the base upright to the curved shield 2.

The curved shield 2 terminates in a rounded end of curved shield 4 and in a bottom end of curved shield 18. The base upright terminates at a top of base upright 6. The base upright 16 and the curved shield 2 may be composed of any rigid tube-shaped material such as polyvinyl chloride (PVC), steel, or the like which is strong enough to hold the weight of the bed covers.

The base upright 16 and the curved shield 2 may be powder coated or otherwise treated for the comfort of a user. The rounded end of curved shield 4 may be a cap made out of plastic, rubber, or the like.

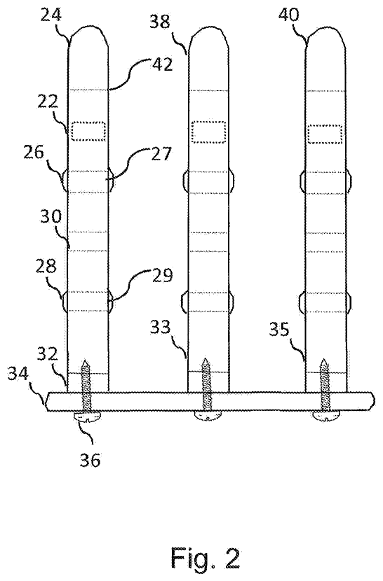

FIG. 2 shows a rear view of the present invention. A plurality of curved shields is exemplified by first curved shield 24, second curved shield 38, and third curved shield 40. A plurality of base uprights is exemplified by a first base upright 32, a second base upright 33, and a third base upright 35.

A base 34 is of less width than a mattress but enough width to support at least base upright 32, base upright 33, base upright 35, curved shield 24, curved shield 38, and curved shield 40. Base mounting screw 36 mounts the base upright 32 to the base 34.

Other types of fasteners could be used so that the base upright 32 is securely mounted to the base 34. Similarly, base upright 33 and base upright 35 are mounted to the base 34.

The curved shield 24 is tube-shaped and sufficiently larger or smaller than the base upright 32 so that part of the two tubes fit inside each other. The base upright contains a hole 30, a first hole 27, and a second hole 28. The curved shield contains hole 22, first hole 27, and second hole 29.

First upright adjustment screws 26 come in pairs and attach through the first hole 27 to secure the base upright 32 to the curved shield 24. Second upright adjustment screws come in pairs and attach through the second hole 29 to secure the base upright 32 to the curved shield 24. Hole 30 and hole 22 could be used to make the height of the invention adjustable to fit mattresses of different depths and feet of different lengths. Upright base 33 is similarly attached to curved shield 38, and upright base 35 is similarly attached to curved shield 40.

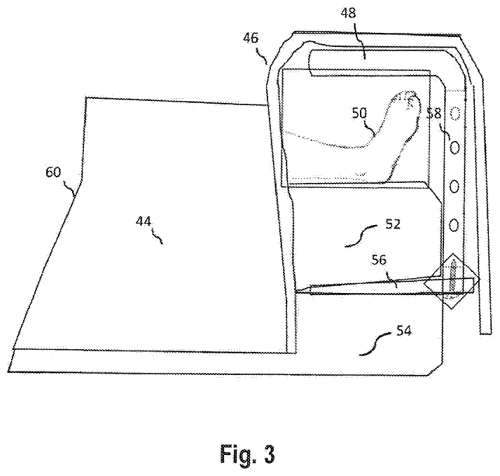

In FIG. 3 the invention is shown in side view in one example of operation. A side view of a bed cover 44 is shown in cut away view 46. The cut away edge of the bed 60 would continue to the left.

The base 56 is inserted between a mattress 52 and box springs 54 with such tension as to hold the invention tight. The plurality of curved shields 48 hold the bed cover 44 above the foot of a user 50.

The foot of a user 50 does not come in contact with the invention. The present invention supports the bed cover 44 so that the bed cover does not come in contact with the foot of a user 50. Unlike some prior art, the present invention provides three curved shields 48 giving more support for bed covers 44.

It will be apparent to those skilled in the art that changes and modifications may be made in the embodiments illustrated, without departing from the spirit and scope of the invention. Thus, the invention is not to be limited to the particular forms herein shown and described except insofar as indicated by the scope of the appended claims.

1. A device for relieving the weight of bed covers comprising of a base, a plurality of base uprights, and a plurality of curved shields.

2. The device for relieving the weight of bed covers comprising of the base, the plurality of base uprights, and the plurality of curved shields as in claim 1, wherein the base is affixed between the mattress and box spring.

3. The device for relieving the weight of bed covers comprising of the base, the plurality of base uprights, and the plurality of curved shields as in claim 1, wherein the base is affixed to the plurality of base uprights.

4. The device for relieving the weight of bed covers comprising of the base, the plurality of base uprights, and the plurality of curved shields as in claim 1, wherein the plurality of base uprights are adjustable so as to provide room for the user's feet.

5. The device for relieving the weight of bed covers comprising of the base, the plurality of base uprights, and the plurality of curved shields as in claim 1, wherein the plurality of base uprights are affixed to the plurality of curved shields.

6. The device for relieving the weight of bed covers comprising of the base, the plurality of base uprights, and the plurality of curved shields as in claim 1, wherein the plurality of curved shields is made from a rigid material so as to support the weight of the covers.

7. A method of manufacturing a device for relieving the weight of bed covers comprising of a base, a plurality of base uprights, and a plurality of curved shields.

8. The method of manufacturing the device for relieving the weight of bed covers comprising of the base, the plurality of base uprights, and the plurality of curved shields as in claim 7, wherein the base is affixed between the mattress and box spring.

9. The method of manufacturing the device for relieving the weight of bed covers comprising of the base, the plurality of base uprights, and the plurality of curved shields as in claim 7, wherein the base is affixed to the plurality of base uprights.

10. The method of manufacturing the device for relieving the weight of bed covers comprising of the base, the plurality of base uprights, and the plurality of curved shields as in claim 7, wherein the plurality of base uprights are adjustable so as to provide room for the user's feet.

11. The method of manufacturing the device for relieving the weight of bed covers comprising of the base, the plurality of base uprights, and the plurality of curved shields as in claim 7, wherein the plurality of base uprights are affixed to the plurality of curved shields.

12. The method of manufacturing the device for relieving the weight of bed covers comprising of the base, the plurality of base uprights, and the plurality of curved shields as in claim 7, wherein the plurality of curved shields is made from a rigid material so as to support the weight of the covers.

13. A method of using a device for relieving the weight of bed covers comprising of a base, a plurality of base uprights, and a plurality of curved shields.

14. The method of using the device for relieving the weight of bed covers comprising of the base, the plurality of base uprights, and the plurality of curved shields as in claim 13, wherein the base is affixed between the mattress and box spring.

15. The method of using the device for relieving the weight of bed covers comprising of the base, the plurality of base uprights, and the plurality of curved shields as in claim 13, wherein the base is affixed to the plurality of base uprights.

16. The method of using the device for relieving the weight of bed covers comprising of the base, the plurality of base uprights, and the plurality of curved shields as in claim 13, wherein the plurality of base uprights are adjustable so as to provide room for the user's feet.

17. The method of using the device for relieving the weight of bed covers comprising of the base, the plurality of base uprights, and the plurality of curved shields as in claim 13, wherein the plurality of base uprights are affixed to the plurality of curved shields.

18. The method of using the device for relieving the weight of bed covers comprising of the base, the plurality of base uprights, and the plurality of curved shields as in claim 13, wherein the plurality of curved shields is made from a rigid material so as to support the weight of the covers.
